(19) United States
(12) Patent Application Publication
(10) Pub. No.: US 2019/0034965 A1
(43) Pub. Date: Jan. 31, 2019

(54) BILLBOARD INFORMATION RETRIEVAL SYSTEM

(71) Applicant: Luke Ledger, Phenix City, AL (US)

(72) Inventor: Luke Ledger, Phenix City, AL (US)

(21) Appl. No.: 15/660,617

(22) Filed: Jul. 26, 2017

(51) Int. Cl. G06Q 30/02

(52) U.S. Cl. CPC G06Q 30/0261; G06Q 30/0267

(57) ABSTRACT

Implementations of a billboard information retrieval system is provided. In some implementations, billboard information retrieval system comprises a computer implemented method for displaying a user interface at a portable computing device. In some implementations, the user interface comprises a display element for advertisement symbol wherein the display elements for the advertisement symbols comprises symbols that are the same symbol as advertisement symbols displayed on billboard advertisements within a predetermined area of the location of the portable computing device. In some implementations, the display elements for the advertisement symbols and a predetermined number of other display elements are the only display elements on the first user interface that are selectable on the user interface. In some implementations, the user interface is dynamic. In some implementations, the user interface may change as the location of the portable computing device changes and the available advertisements or advertisement symbols changes.

### TECHNICAL FIELD

This disclosure relates to implementations of a billboard information retrieval system.

### BACKGROUND

Billboards display advertisements for various products and services to passing drivers. However, it is difficult for a driver passing a billboard to safely and efficiently gather sufficient information from the billboards. Vehicle speed, traffic conditions, weather conditions, or other distracting or inhibiting factors make it difficult for a passing driver to retrieve information from the billboards.

For example, a driver seeking a restaurant may pass a billboard advertising a restaurant. The driver may not be able to obtain all of the restaurant information, such as the phone number and address, because of vehicle speed, traffic conditions, weather conditions, or any other reason. The driver may have some available alternatives to try to get this missed billboard advertisement information or otherwise find a restaurant. For example, the driver may use a mobile or vehicle-equipped device to conduct a series of distracting and potentially dangerous tasks to try to search for the information. As another example, the driver may drive around in search of the restaurant, which may be time consuming, waste fuel, or may be futile in the event the driver does not find the restaurant.

U.S. Patent Appl. Pub. No. 2016/0063559 (“'559 Patent Appl.”) discloses a method and apparatus for accessing advertising content from a mobile device. However, the '559 Patent Appl. does not disclose a simplified user interface for accessing advertising content or a simplified user interface for entering information by the user, such as the code for the advertising content.

### BRIEF DESCRIPTION OF THE DRAWINGS

FIG. 1 illustrates an implementation of an example environment of a billboard information retrieval system according to the present disclosure.

FIG. 2 illustrates an example computer system, which may be used with implementations of the present disclosure.

FIG. 3 illustrates an implementation of an example billboard according to the present disclosure.

FIG. 4 illustrates an implementation of an example user interface for inputting advertisement symbols displayed on billboards according to the present disclosure.

FIG. 5 illustrates an implementation of an example user interface for additional option buttons according to the present disclosure.

FIG. 6 illustrates an implementation of an example method for billboard information retrieval in the environment of FIG. 1 according to the present disclosure.

### DETAILED DESCRIPTION

Implementations of a billboard information retrieval system are provided. In some implementations, the billboard information retrieval system provides a user with a simplified user interface on a portable computing device for inputting information to retrieve advertising information based on billboard symbols and location information. In some implementations, in response to a selection of an advertisement symbol displayed on a billboard, on the user interface of the portable computing device, pre-stored billboard advertisement data is displayed on the portable computing device.

In some implementations, the billboard information retrieval system may provide a user with a simplified user interface on a portable computing device for accessing additional options such as calling, navigation, and retrieving additional information (e.g., menus, discounts, reviews, etc.).

In this way, the billboard information retrieval system allows a user to get desired information quickly, with less distraction, and using fewer button presses or selections on a portable computing device to accomplish billboard information retrieval.

In some implementations, a computer-implemented method for billboard information retrieval is provided. In some implementations, the method comprises receiving advertisement data at a first computing device. In some implementations, the advertisement data is transmitted over a first network from a second computing device.

In some implementations, the method further comprises associating at the first computing device the advertisement data to an advertisement symbol and a location.

In some implementations, the method further comprises receiving a first request at the first computing device. In some implementations, the first request is transmitted over a second network from a third computing device. In some implementations, the first request comprises the location of the third computing device and a request for advertisement symbols within a predetermined area of the location of the third computing device.

In some implementations, the method further comprises retrieving at the first computing device any advertisement symbols associated with a location that is within a predetermined area of the location of the third computing device.

In some implementations, the method further comprises transmitting at the first computing device any retrieved advertisement symbols to the third computing device. In some implementations, the retrieved advertisement symbols are associated with a location that is within a predetermined area of the received location of the third computing device.

In some implementations, the method further comprises displaying a first user interface at the third computing device. In some implementations, the user interface comprises a display element for each received advertisement symbol. In some implementations, the display elements for the received advertisement symbols comprises symbols that are the same symbol as advertisement symbols displayed on billboard advertisements within a predetermined area of the received location of the third computing device. In some implementations, the display elements for the received advertisement symbols and a predetermined number of other display elements are the only display elements on the first user interface that are selectable on the user interface.

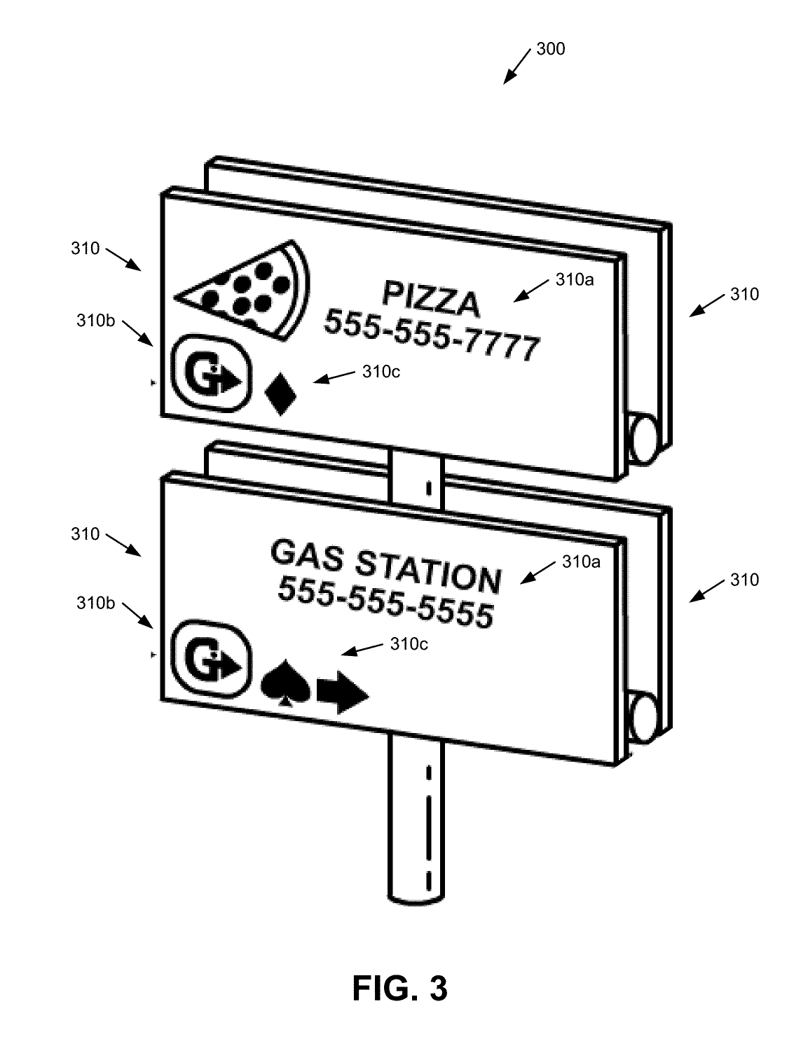

Referring to FIG. 3, for example, in some implementations, the billboard information retrieval system of the present disclosure comprises one or more billboards 300.

In some implementations, the billboard 300 comprises one or more billboard advertisements 310 displayed on the billboard 300.

In some implementations, the billboard advertisements 310 comprise billboard advertisement data 310a.

In some implementations, the billboard advertisement data 310a comprises a business name related to the billboard advertisement 310. In some implementations, the billboard advertisement data 310a comprises a product name related to the billboard advertisement 310.

In some implementations, the billboard advertisement data 310a comprises a phone number related to the billboard advertisement 310.

In some implementations, the billboard advertisement data 310a comprises an address related to the billboard advertisement 310.

In some implementations, the billboard advertisement data 310a comprises additional information related to the billboard advertisement 310.

In some implementations, the additional information comprises an image related to the billboard advertisement 310. In some implementations, the additional information comprises a menu related to the billboard advertisement 310.

In some implementations, the additional information comprises a discount related to the billboard advertisement 310. In some implementations, the additional information comprises a review comment related to the billboard advertisement 310.

In some implementations, the additional information comprises any other suitable data related to the billboard advertisement 310.

In some implementations, the billboard 300 comprises an icon 310b, associated with the billboard information retrieval system, displayed on the billboard 300. In some implementations, the displayed icon 310b on the billboard 300 indicates an association of the billboard information retrieval system to the billboard advertisements 310.

In some implementations, the billboard 300 comprises a geo-referenced symbol or advertisement symbol 310c for the billboard advertisement data 310a displayed on the billboard 300.

In some implementations, the advertisement symbol 310c is displayed on the billboard 300 adjacent to the icon 310b. In some implementations, the advertisement symbol 310c is displayed in any other suitable location on the billboard 300.

In some implementations, a different advertisement symbol 310c is displayed on a billboard 300 for each billboard advertisement 310 displayed on the billboard 300. In some implementations, a different advertisement symbol 310c is displayed on each billboard advertisement panel 310 of a rotating billboard (not depicted). In some implementations, a different advertisement symbol 310c is displayed on each billboard advertisement display 310 of an electronic billboard (not depicted).

In some implementations, the same advertisement symbol 310c may be displayed on billboard at different locations. In this case, the billboards and related pre-stored billboard advertisement data are distinguished based on the location of the portable computing device.

In some implementations, as will be discussed in more detail below, each advertisement symbol 310c for the billboard advertisements 310 displayed on billboards 300 located within a predetermined area (i.e., a “geo-referenced area”) of a portable computing device (including a vehicle) having a billboard information retrieval application of the present disclosure operative thereon may be displayed for selection on a user interface of the portable computing device.

In some implementations, the geo-referenced area is an area within a predetermined radius from the portable computer device. In some implementations, the geo-referenced area may be smaller or larger based on the number of billboard advertisements within a predetermined area of the portable computer device. For example, in some implementations, the larger the number of billboard advertisements within a predetermined area of the portable computer device, the smaller the geo-referenced area.

In some implementations, if there is only one billboard advertisement 310 in the geo-referenced area of a portable computing device, then only a single corresponding advertisement symbol 310c may be displayed on the user interface of the portable computing device. In some implementations, if there is more than one billboard advertisement 310 in the geo-referenced area of a portable computing device, then only the corresponding advertisement symbols 310c are displayed on the user interface of the portable computing device.

In some implementations, the billboard advertisement data to be retrieved by a portable computing device and associated with an advertisement symbol 310c on a billboard 300 may be uploaded from, for example, an advertisement company to a content server of the billboard information retrieval system. In some implementations, the billboard advertisement data is uploaded via a virtual private network (VPN). In some implementations, the billboard advertisement data is uploaded in any other suitable manner.

In some implementations, the uploaded billboard advertisement data is associated with an advertisement symbol displayed on a billboard. In some implementations, the uploaded billboard advertisement data is associated with the billboard location.

In some implementations, the billboard advertisement data uploaded to the content server and stored may comprise the billboard advertisement data 310a displayed on the billboard 300. In some implementations, the uploaded billboard advertisement data may comprise a business name related to the billboard advertisement. In some implementations, the uploaded billboard advertisement data may comprise a product name related to the billboard advertisement. In some implementations, the uploaded billboard advertisement data may comprise a phone number related to the billboard advertisement. In some implementations, the uploaded billboard advertisement data may comprise an address related to the billboard advertisement. In some implementations, the uploaded billboard advertisement data may comprise any additional information related to the billboard advertisement. In some implementations, the additional information may comprise an image related to the billboard advertisement. In some implementations, the additional information may comprise a menu related to the billboard advertisement. In some implementations, the additional information may comprise a discount related to the billboard advertisement. In some implementations, the additional information may comprise one or more comments, e.g., reviews, related to the billboard advertisement. In some implementations, the additional information may comprise any other suitable data related to the billboard advertisement.

A user with a billboard information retrieval application of the present disclosure operative on a portable computing device (including a vehicle) may retrieve pre-stored billboard advertisement data associated with a billboard by inputting to the billboard information retrieval application the advertisement symbol displayed on the billboard. In some implementations, the billboard information retrieval system can be downloaded and installed to a cellular or mobile portable computing device as a mobile application.

In some implementations, the portable computing device may transmit a request to retrieve pre-stored billboard advertisement data to a content server over a network. In some implementations, the pre-stored billboard advertisement data may be automatically downloaded to a user's portable computing device and retrieved from the portable computing device.

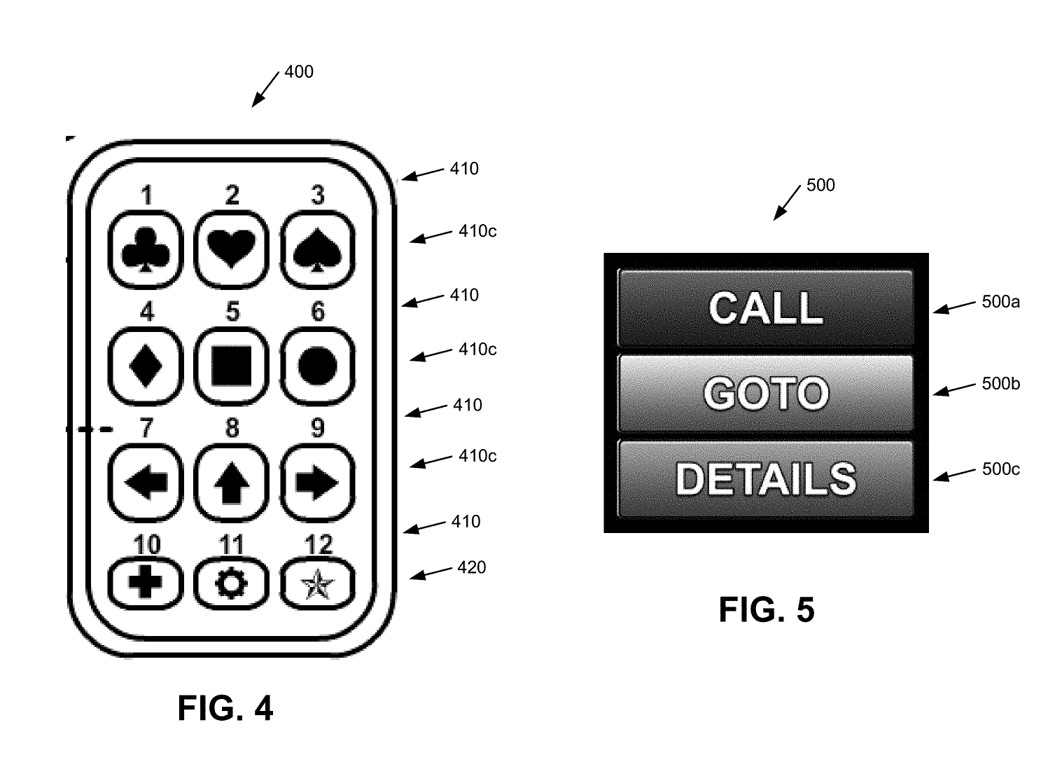

FIG. 4 illustrates an implementation of an example user interface 400 displayed on a portable computing device for inputting an advertisement symbol displayed on billboards to request pre-stored billboard advertisement data. In some implementations, the user interface 400 may be dynamic. In some implementations, the user interface 400 may change as the geo-referenced area changes (e.g., as the location of a portable computing device changes). In some implementations, the user interface 400 changes based on the available advertisements within the geo-referenced area.

As discussed above, each advertisement symbol 310c for the billboard advertisements 310 displayed on billboards 300 located within a predetermined area of a user's portable computing device (i.e., a “geo-referenced area”) may be displayed on the portable computing device as a symbol 410c for selection. Thus, in some implementations, the advertisement symbols 410 displayed on the user interface 400 of a portable computing device may represent advertisement symbols 310c used on billboard advertisements within a geo-referenced area of the portable computing device.

In some implementations, the advertisement symbols 410c displayed on the user interface 400 may represent advertisement symbols 310c used on billboard advertisements within the billboard information retrieval system. However, in some implementations, only the advertisement symbols used on billboard advertisements within a geo-referenced area of a portable computing device may be active or selectable. In some implementations, the advertisement symbols that are not used on billboard advertisements within a geo-referenced area of a portable computing device may be a different shade than advertisement symbols used on billboard advertisements within a geo-referenced area of the portable computing device to indicate that the advertisement symbols that are not used on billboard advertisements within a geo-referenced area are not active or selectable. Thus, in some implementations, when an active advertisement symbol 410c is selected, the portable computing device may retrieve and display pre-stored billboard advertisement data associated with the advertisement symbol. When an advertisement symbol 410c that is not active is selected, the portable computing device may not retrieve and display pre-stored billboard advertisement data associated with the advertisement symbol.

In some implementations, the advertisement symbols that are not used on billboard advertisements within a geo-referenced area of a portable computing device may not be displayed on the user interface 400 of the portable computing device.

In some implementations, each advertisement symbol 410c displayed on the user interface 400 may be a selectable icon or button.

In some implementations, the display 400 may comprise a number 410 associated with the advertisement symbols 410c. In some implementations, the number may be used for a voice command or voice activation feature of the billboard information retrieval application. That is, the user may speak the number associated with a symbol to the billboard information retrieval application to retrieve pre-stored billboard advertisement data associated with a billboard. In some implementations, element 410 may be a letter or words. In some implementations, element 410 may be any other suitable voice-capable character.

In some implementations, selecting or activating an advertisement symbol 410c displayed on the user interface 400 causes associated billboard advertisement data to be displayed on the portable computing device 110 or on any display linked to the portable computing device 100, for example, a vehicle display.

In some implementations, once a user selects an advertisement symbol 410c displayed on the user interface 400, the billboard information retrieval application of the present disclosure provides a limited menu for additional options. FIG. 5 illustrates an implementation of an example user interface 500 that may be displayed providing a limited menu once a user selects an advertisement symbol 410c displayed on the user interface 400. In some implementations, the user interface 500 may be displayed once the user makes an additional selection after selecting an advertisement symbol 410c displayed on the user interface 400. In some implementations, a CONTINUE button may be displayed on the portable computing device in response to selecting or activating the advertisement symbol 410c to display additional options or information associated with advertisement symbol 410c. In some implementations, the user interface 500 of FIG. 5 may be displayed along with the user interface 400 of FIG. 4.

In some implementations, the limited menu may comprise three menu options. In some implementations, the limited menu may comprise at most three menu options. In some implementations, the limited menu may comprise more than three menu options. As shown in FIG. 5, the billboard information retrieval application of the present disclosure may display a limited menu comprising three menu option selections 500a, 500b, and 500c. In some implementations, the limited menu may comprise a “CALL” option selection 500a, a “GOTO” option selection 500b, and a “DETAILS” option selection 500c. In some implementations, the limited menu may comprise any other suitable selections.

In some implementations, when the “CALL” option selection 500a is selected, the billboard information retrieval application is configured to instruct the portable computing device to call a phone number associated with the advertisement symbol 410c selected by the user. In some implementations, when the “CALL” option selection 500a is selected, the billboard information retrieval application is configured to display a phone number associated with the advertisement symbol 410c selected by the user.

In some implementations, the phone number associated with the advertisement symbol 410c selected by the user is the phone number saved in the content server associated with the advertisement symbol 410c selected by the user and a location within the geo-referenced area of the portable computing device.

In some implementations, the billboard information retrieval application may utilize a location service of the portable computing device to determine the location of the portable computing device.

Accordingly, in some implementations, the billboard information retrieval application uses the location data of the portable computing device and the advertisement symbol 410c selected by the user to retrieve from the content server the the phone number associated with the advertisement symbol 410c selected by the user. In some implementations, the billboard information retrieval application system uses the received location data and the received advertisement symbol 410c selected by the user provided by the billboard information retrieval application to search the content server for the phone number associated with the received advertisement symbol 410c and a location within a predetermined area of the received location. In some implementations, the billboard information retrieval application system uses the received location data and the received advertisement symbol 410c selected by the user provided by the billboard information retrieval application to search the content server for the phone number associated with the received advertisement symbol 410c and a location closest to the received location.

In some implementations, when the “GOTO” option selection 500b is selected, the billboard information retrieval application is configured to display an address associated with the advertisement symbol 410c selected by the user.

In some implementations, when the “GOTO” option selection 500b is selected, the billboard information retrieval application is configured to display the address associated with the advertisement symbol 410c selected by the user. In some implementations, when the “GOTO” option selection 500b is selected, the billboard information retrieval application is configured to display an option selection for a user to select to instruct a navigation application of the portable computing device to use the address associated with the advertisement symbol 410c selected by the user to navigate the user to the address. In some implementations, when the “GOTO” option selection 500b is selected, the billboard information retrieval application is configured to instruct the portable computing device to use a navigation application of the portable computing device and provide the navigation application with an address associated with the advertisement symbol 410c selected by the user to navigate the user to the address.

In some implementations, the address associated with the advertisement symbol 410c selected by the user is the address saved in the content server associated with the advertisement symbol 410c and a location within the geo-referenced area of the portable computing device. In some implementations, the address associated with the advertisement symbol 410c selected by the user is the address saved in the content server associated with the advertisement symbol 410c and a location closest to the location of the portable computing device.

In some implementations, when the “DETAILS” option selection 500c is selected, the billboard information retrieval application is configured to display additional information associated with the advertisement symbol 410c selected by the user. In some implementations, the additional information may be menus, discounts, or comments associated with the advertisement symbol 410c selected by the user.

In some implementations, the additional information associated with the advertisement symbol 410c selected by the user is the additional information saved in the content server associated with the advertisement symbol 410c and a location within the geo-referenced area of the portable computing device. In some implementations, the additional information associated with the advertisement symbol 410c selected by the user is the additional information saved in the content server associated with the advertisement symbol 410c and a location closest to the location of the portable computing device.

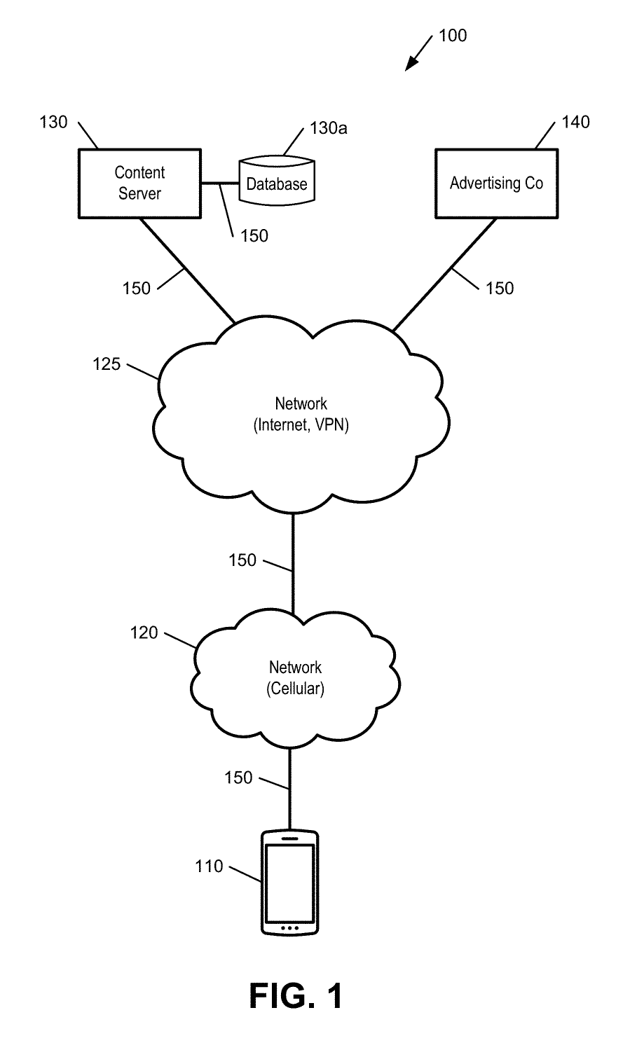

FIG. 1 illustrates an implementation of an example environment 100 of a billboard information retrieval system according to the present disclosure.

As shown in FIG. 1, in some implementations, the environment 100 may include one or more client devices 110, a wireless cellular network 120, a network 125, and one or more servers 130, and one or more advertising company client devices 140. In some implementations, the example billboard information retrieval system environment 100 also may include one or more data storage 130a1 linked to one or more servers 130.

In some implementations, a client device 110 may be used by users of the billboard information retrieval system to retrieve pre-stored billboard advertisement data associated with a billboard from the content server 130 or to access other functions of the billboard information retrieval system of the present disclosure discussed above.

In some implementations, a client device 140 may be used by an advertising company to upload billboard advertisement data to the content server 130 as discussed above.

The client device 110 is depicted as a mobile phone, but the client device 110 may comprise any type of portable computing device, such as a laptop, cellular phone, a smart device, a mobile telephone, a tablet-style computer, or any other handheld electronic device capable of wireless communication. In some implementations, the client device 110 is configured to interact with the server device 130 via an application, such as a native application, residing on the client device 110.

The client device 140 may be any type of computing device, such as a desktop computer system, a laptop, cellular phone, a smart device, a mobile telephone, a tablet-style computer, or any other device capable of wireless or wired communication. Client device 140 is configured to interact with the server 130 via an application, such as a web browser or a native application, residing on the client device 140.

In some implementations, the client devices 110, 140 includes hardware, software, or embedded logic components or a combination of two or more such components and is configured to carry out the appropriate functions implemented or supported by the client devices 110, 140.

In some implementations, the client devices 110, 140 may include one or more processors, one or more memories, one or more displays, one or more interfaces, one or more components capable of inputting data, one or more components capable of outputting data, one or more components capable of communicating with any other component of the environment 100 of the billboard information retrieval system, or any other component suitable for a particular purpose.

In some implementations, the client devices 110, 140 are configured to access networks 120 and/or 125. In some implementations, the client devices 110, 140 are configured to communicate with server 130.

In some implementations, the client device 110 can connect to the network 125 through a wireless cellular network 120, such as GPRS-based and CDMA-based wireless networks, as well as 802.16 WiMax and long-range wireless data networks.

In some implementations, components of the billboard information retrieval system environment 100 may communicate with any other component of the environment 100 over network 125. Network 125 may be any suitable network. In some implementations, for example, one or more portions of network 125 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another network 125, or a combination of two or more of the foregoing.

In some embodiments, components of the billboard information retrieval system environment 100 may be configured to communicate over links 150. Links 150 may connect components of the environment 100 to networks 120, 125 or to each other. In some implementations, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links 150. Links 150 may not be the same throughout the environment 100.

In some implementations, the server device 130 may include a processor, memory, user accounts, and one or more modules to perform various functions.

In some implementations, each server 130 may be a unitary server or may be a distributed server spanning multiple computers or multiple datacenters. Servers 130 may be of various types, such as, for example and without limitation, web server, file server, application server, exchange server, database server, or proxy server. In some implementations, each server 130 may include hardware, software, or embedded logic components or a combination of two or more such components for carrying out the appropriate functionalities implemented or supported by server 130. For example, a web server is generally capable of hosting websites containing web pages or particular elements of web pages. More specifically, a web server may host HTML files or other file types, or may dynamically create or constitute files upon a request, and communicate them to clients 110, 140 in response to HTTP or other requests from clients 110, 140. A database server is generally capable of providing an interface for managing data stored in one or more data stores.

In some implementations, one or more data storages 130a1 may be communicatively linked to one or more servers 130 via one or more links 150. In some implementations, data storages 130a1 may be used to store various types of information (e.g., an advertisement symbol, a location, billboard advertisement data, a business name, a product name, a phone number, an address, an image, a menu, a discount, comments, etc.). In some implementations, the information stored in data storages 130a1 may be organized according to specific data structures. In particular embodiment, each data storage 130a1 may be a relational database. Particular embodiments may provide interfaces that enable servers 130 or clients 110, 140 to manage, e.g., retrieve, modify, add, or delete, the information stored in data storage 130a1.

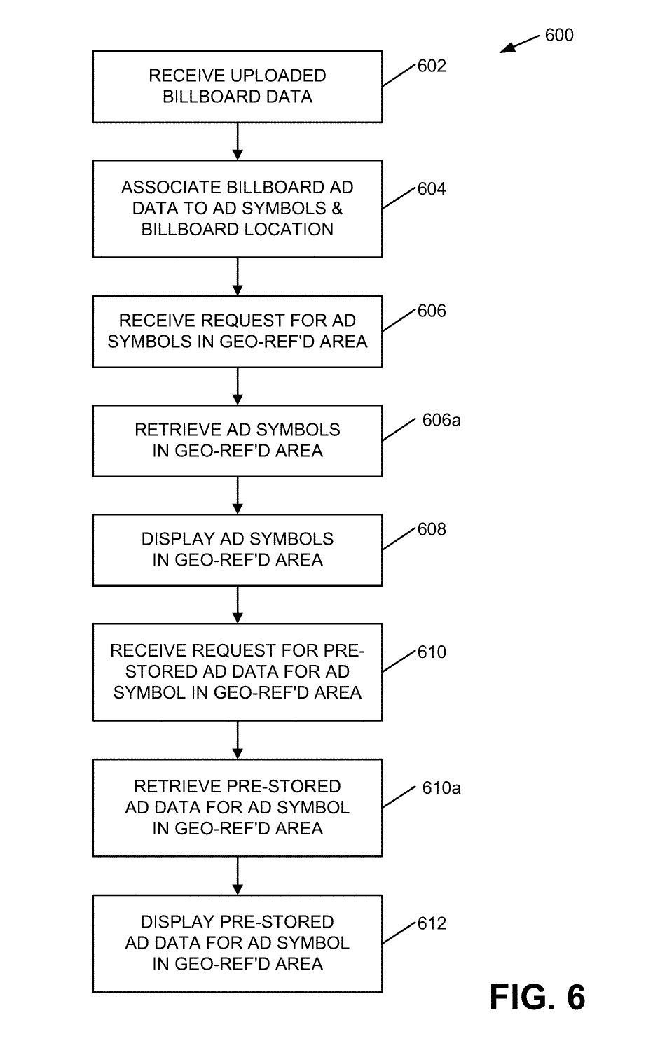

FIG. 6 illustrates an implementation of an example method 600 for billboard information retrieval in the environment 100 of FIG. 1 according to the present disclosure.

In some implementations, the method 600 comprises receiving 602 uploaded billboard advertisement data associated with billboard advertisement data 310a displayed on a billboard advertisement 310 of a billboard 300.

In some implementations, the uploaded billboard advertisement data is received from an advertising company computing device 140. In some implementations, the uploaded billboard advertisement data is received by a content server 130.

In some implementations, the uploaded billboard advertisement data is transmitted over a link 150 and/or a first network 125. In some implementations, the first network 125 is a virtual private network (VPN).

In some implementations, the method 600 comprises associating 604 the uploaded billboard advertisement data to an advertisement symbols 310a and a location.

In some implementations, the uploaded billboard advertisement data is associated to an advertisement symbols 310a and a location using a database 130a1 linked to the content server 130.

In some implementations, the method 600 comprises receiving 606 a request for advertisement symbols 310c within a predetermined area of a portable computing device.

In some implementations, the request for advertisement symbols 310c within a predetermined area of a portable computing device is received from a portable computing device 110. In some implementations, the request for advertisement symbols 310c within a predetermined area of a portable computing device is received by the content server 130. In some implementations, the request is transmitted over a link 150 and/or a second network. In some implementations, the second network comprises an internet network 125 and a cellular network 120.

In some implementations, the method 600 comprises retrieving 606a from the content server 130 advertisement symbols 310c associated with a location that is within a predetermined area of the location of a portable computing device and transmitting the advertisement symbols 310c to the portable computing device.

In some implementations, the method 600 comprises displaying 608 the advertisement symbols within a predetermined area of a portable computing device. In some implementations, the displaying 608 is on the portable computing device 110.

In some implementations, the method 600 comprises receiving 610 a request for pre-stored advertisement data based an advertisement symbol and a location of a portable computing device.

In some implementations, the request for pre-stored advertisement data based an advertisement symbol and a location of a portable computing device is received from a portable computing device 110. In some implementations, the request for pre-stored advertisement data based an advertisement symbol and a location of a portable computing device is received by the content server 130. In some implementations, the request for pre-stored advertisement data based an advertisement symbol and a location of a portable computing device is received by the portable computing device 110. In some implementations, the request is transmitted over a link 150 and/or a second network. In some implementations, the second network comprises an internet network 125 and a cellular network 120.

In some implementations, the method 600 comprises retrieving 610a from the content server 130 pre-stored advertisement data associated with an advertisement symbol and a location that is within a predetermined area of the location of a portable computing device and transmitting the advertisement symbols 310c to the portable computing device.

In some implementations, the method 600 comprises displaying 612 the pre-stored advertisement data on the portable computing device 110.

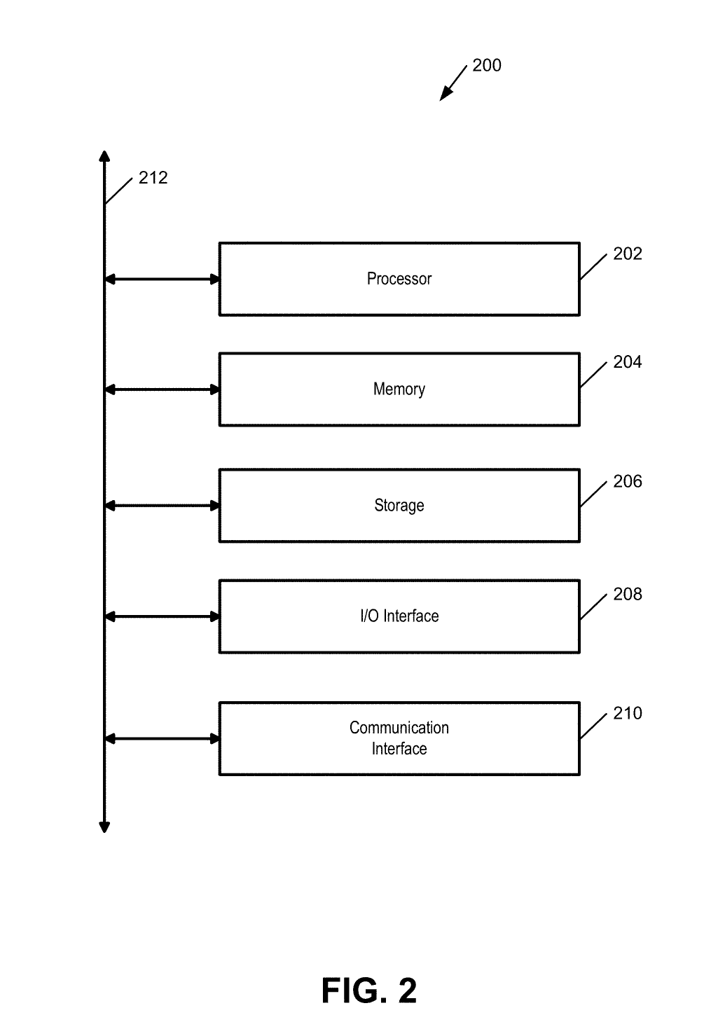

FIG. 2 illustrates an example computer system 200, which may be used with some implementations of the present invention. This disclosure contemplates any suitable number of computer systems 200.

This disclosure contemplates computer system 200 taking any suitable physical form. In some implementations, as an example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these.

In some implementations, where appropriate, computer system 200 may include one or more computer systems 200; be unitary or distributed; span multiple locations; span multiple machines; or reside in a cloud, which may include one or more cloud components in one or more networks.

In some implementations, where appropriate, one or more computer systems 200 may perform without substantial spatial or temporal limitation one or more steps of one or more methods described or illustrated herein. In some implementations, as an example and not by way of limitation, one or more computer systems 200 may perform in real time or in batch mode one or more steps of one or more methods described or illustrated herein. In some implementations, one or more computer systems 200 may perform at different times or at different locations one or more steps of one or more methods described or illustrated herein, where appropriate.

In some implementations, computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In some implementations, processor 202 includes hardware for executing instructions, such as those making up a computer program. In some implementations, as an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206.

In some implementations, processor 202 may include one or more internal caches for data, instructions, or addresses. The present disclosure contemplates processor 202 including any suitable number of any suitable internal caches, where appropriate. In some implementations, as an example and not by way of limitation, processor 202 may include one or more instruction caches, one or more data caches, and one or more translation look-aside buffers (TLBs).

In some implementations, instructions in the instruction caches may be copies of instructions in memory 204 or storage 206, and the instruction caches may speed up retrieval of those instructions by processor 202.

In some implementations, data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data.

In some implementations, the data caches may speed up read or write operations by processor 202. In some implementations, the TLBs may speed up virtual-address translation for processor 202.

In some implementations, processor 202 may include one or more internal registers for data, instructions, or addresses. The present disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In some implementations, memory 204 includes main memory for storing instructions for processor 202 to execute or data for processor 202 to operate on. In some implementations, as an example and not by way of limitation, computer system 200 may load instructions from storage 206 or another source (such as, for example, another computer system 200) to memory 204.

In some implementations, processor 202 may then load the instructions from memory 204 to an internal register or internal cache. In some implementations, to execute the instructions, processor 202 may retrieve the instructions from the internal register or internal cache and decode them.

In some implementations, during or after execution of the instructions, processor 202 may write one or more results (which may be intermediate or final results) to the internal register or internal cache. In some implementations, processor 202 may then write one or more of those results to memory 204.

In some implementations, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere).

In some implementations, one or more memory buses (which may each include an address bus and a data bus) may couple processor 202 to memory 204. In some implementations, bus 212 may include one or more memory buses, as described below.

In some implementations, one or more memory management units (MMUs) reside between processor 202 and memory 204 and facilitate accesses to memory 204 requested by processor 202.

In some implementations, memory 204 includes random access memory (RAM). In some implementations, this RAM may be volatile memory, where appropriate.

In some implementations, where appropriate, this RAM may be dynamic RAM (DRAM) or static RAM (SRAM). Moreover, in some implementations, where appropriate, this RAM may be single-ported or multi-ported RAM. The present disclosure contemplates any suitable RAM.

In some implementations, memory 204 may include one or more memories 204, where appropriate. Although this disclosure describes and illustrates particular memory, this disclosure contemplates any suitable memory.

In some implementations, storage 206 includes mass storage for data or instructions. In some implementations, as an example and not by way of limitation, storage 206 may include an HDD, a floppy disk drive, flash memory, an optical disc, a magneto-optical disc, magnetic tape, or a Universal Serial Bus (USB) drive or a combination of two or more of these.

In some implementations, storage 206 may include removable or non-removable (or fixed) media, where appropriate. In some implementations, storage 206 may be internal or external to computer system 200, where appropriate. In some implementations, storage 206 is non-volatile, solid-state memory.

In some implementations, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form.

In some implementations, storage 206 may include one or more storage control units facilitating communication between processor 202 and storage 206, where appropriate. In some implementations, where appropriate, storage 206 may include one or more storages 206. Although this disclosure describes and illustrates particular storage, this disclosure contemplates any suitable storage.

In some implementations, I/O interface 208 includes hardware, software, or both providing one or more interfaces for communication between computer system 200 and one or more I/O devices. In some implementations, computer system 200 may include one or more of these I/O devices, where appropriate.

In some implementations, one or more of these I/O devices may enable communication between a person and computer system 200. In some implementations, as an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these.

In some implementations, an I/O device may include one or more sensors. This disclosure contemplates any suitable I/O devices and any suitable I/O interfaces 208 for them.

In some implementations, where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In some implementations, communication interface 210 includes hardware, software, or both providing one or more interfaces for communication (such as, for example, packet-based communication) between computer system 200 and one or more other computer systems 200 or one or more networks.

In some implementations, as an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it.

In some implementations, as an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these.

In some implementations, one or more portions of one or more of these networks may be wired or wireless. In some implementations, as an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In some implementations, computer system 200 may include any suitable communication interface 210 for any of these networks, where appropriate. In some implementations, communication interface 210 may include one or more communication interfaces 210, where appropriate. Although this disclosure describes and illustrates a particular communication interface, this disclosure contemplates any suitable communication interface.

In some implementations, bus 212 includes hardware, software, or both coupling components of computer system 200 to each other. In some implementations, as an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these.

In some implementations, bus 212 may include one or more buses 212, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. In some implementations, as an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate.

Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101.

This disclosure contemplates one or more computer-readable storage media implementing any suitable storage. In some implementations, a computer-readable storage medium implements one or more portions of processor 202 (such as, for example, one or more internal registers or caches), one or more portions of memory 204, one or more portions of storage 206, or a combination of these, where appropriate.

In some implementations, a computer-readable storage medium implements RAM or ROM. In some implementations, a computer-readable storage medium implements volatile or persistent memory.

In some implementations, one or more computer-readable storage media embody software. Herein, reference to software may encompass one or more applications, bytecode, one or more computer programs, one or more executables, one or more instructions, logic, machine code, one or more scripts, or source code, and vice versa, where appropriate.

In some implementations, software includes one or more application programming interfaces (APIs). This disclosure contemplates any suitable software written or otherwise expressed in any suitable programming language or combination of programming languages.

In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code).

In some implementations, software is expressed in JAVA. In some implementations, software is expressed in Hyper Text Markup Language (HTML), Extensible Markup Language (XML), or other suitable markup language.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example. it will apparent to one of ordinary skill in the art that the invention may be used with any electronic network service, even if it is not provided through a website.

Any computer-based system that provides networking functionality can be used in accordance with the present invention even if it relies, for example, on e-mail, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The present disclosure encompasses all changes, substitutions, variations, alterations, and modifications to the example embodiments herein that a person having ordinary skill in the art would comprehend.

1. A computer-implemented method for billboard information retrieval, the method comprising:
receiving advertisement data at a first computing device wherein the advertisement data is transmitted over a first network from a second computing device;
associating at the first computing device the advertisement data to an advertisement symbol and a location;
receiving a first request at the first computing device wherein the first request is transmitted over a second network from a third computing device and wherein the first request comprises the location of the third computing device and a request for advertisement symbols within a predetermined area of the location of the third computing device;
retrieving at the first computing device any advertisement symbols associated with a location that is within a predetermined area of the location of the third computing device;
transmitting at the first computing device any retrieved advertisement symbols to the third computing device wherein the retrieved advertisement symbols are associated with a location that is within a predetermined area of the received location of the third computing device; and
displaying a first user interface at the third computing device wherein the user interface comprises a display element for each received advertisement symbol wherein the display elements for the received advertisement symbols comprises symbols that are the same symbol as advertisement symbols displayed on billboard advertisements within a predetermined area of the received location of the third computing device and wherein the display elements for the received advertisement symbols and a predetermined number of other display elements are the only display elements on the first user interface that are selectable on the user interface.

2. The computer-implemented method of claim 1 wherein the predetermined number of other display elements is four.

3. The computer-implemented method of claim 1 wherein the predetermined number of other display elements is three.

4. The computer-implemented method of claim 1 wherein the predetermined number of other display elements is less than three.

5. The computer-implemented method of claim 1 wherein the first user interface distinguishes selectable display elements from non-selectable display element.

6. The computer-implemented method of claim 1, the method further comprising
when a selectable display element is activated, transmitting at the third computing device the associated advertisement symbol to the first computing device,
retrieving at the first computing device the advertisement data associated with the advertisement symbol transmitted to the first computing device; and
transmitting at the first computing device the retrieve advertisement data to the third computing device wherein the retrieved advertisement data comprises data displayed on billboard advertisements within a predetermined area of the received location of the third computing device

7. The computer-implemented method of claim 1, the method further comprises
transmitting at the first computing device the advertisement data associated with the retrieved advertisement symbols to the third computing device wherein the advertisement data comprises data displayed on billboard advertisements within a predetermined area of the received location of the third computing device and
when a selectable display element is activated, retrieving at the third computing device the advertisement data associated with the activated display element.

8. The computer-implemented method of claim 6, wherein the advertisement data received at the third computing device for the activated selectable display element comprises a phone number, an address, and additional information, the method further comprising:
displaying a second user interface at the third computing device when the selectable display element of the first user interface is activated, wherein the second user interface consist of a first selection, a second selection, and a third selection, wherein:
when the first selection of the second user interface is activated, the third computing device calls the phone number associated with the activated display element of the first user interface;
when the second selection of the second user interface is activated, the third computing device displays the address associated with the activated display element of the first user interface; and
when the third selection of the second user interface is activated, the third computing device displays the additional information associated with the activated display element of the first user interface.

9. The computer-implemented method of claim 7, wherein the advertisement data retrieved at the third computing device for the activated selectable display element comprises a phone number, an address, and additional information, the method further comprising:
displaying a second user interface at the third computing device when the selectable display element of the first user interface is activated, wherein the second user interface consist of a first selection, a second selection, and a third selection, wherein:
when the first selection of the second user interface is activated, the third computing device calls the phone number associated with the activated display element of the first user interface;
when the second selection of the second user interface is activated, the third computing device displays the address associated with the activated display element of the first user interface; and
when the third selection of the second user interface is activated, the third computing device displays the additional information associated with the activated display element of the first user interface.

10. The computer-implemented method of claim 1, when the second selection of the second user interface is activated, the third computing device instructs a navigation application of the third computing device to use the address associated with the activated display element of the first user interface to navigate the third computing device to the address.

11. The computer-implemented method of claim 1, wherein the first network is a virtual private network (VPN).

12. The computer-implemented method of claim 1, wherein the second network is an internet and cellular network.

13. The computer-implemented method of claim 1, wherein the selection of one of the advertisement symbols comprises a touch selection or a voice command selection.

14. A non-transitory computer readable medium containing instructions that, when executed by a processor on a portable computing device, cause the portable computing device to:
receive advertisement symbols at the portable computing device wherein the advertisement symbols are transmitted over a network from a content server wherein each of the advertisement symbols is associated with a location within a predetermined area of a location of the portable computing device,
display a first user interface at the portable computing device wherein the user interface comprises a display element for each received advertisement symbol wherein the display elements for the received advertisement symbols comprises symbols that are the same symbol as advertisement symbols displayed on billboard advertisements within a predetermined area of the location of the portable computing device and wherein the display elements for the received advertisement symbols and a predetermined number of other display elements are the only display elements on the first user interface that are selectable on the user interface;
when a selectable display element is activated, transmit the associated advertisement symbol to the content server and receive at the portable computing device advertisement data associated with the advertisement symbol transmitted to the content retrieving wherein the advertisement data is transmitted over a network from the content server, wherein the advertisement data comprises data displayed on billboard advertisements within a predetermined area of the location of the portable computing device and wherein the advertisement data received at the portable computing device for the activated selectable display element comprises a phone number, an address, and additional information, the non-transitory computer readable medium containing further instructions that, when executed by a processor on the portable computing device, cause the portable computing device to:
display a second user interface at the third computing device when the selectable display element of the first user interface is activated, wherein the second user interface consist of a first selection, a second selection, and a third selection, wherein:
when the first selection of the second user interface is activated, the portable computing device calls the phone number associated with the activated display element of the first user interface;
when the second selection of the second user interface is activated, the portable computing device displays the address associated with the activated display element of the first user interface; and
when the third selection of the second user interface is activated, the portable computing device displays the additional information associated with the activated display element of the first user interface.

15. A non-transitory computer readable medium containing instructions that, when executed by a processor on a portable computing device, cause the portable computing device to:
receive advertisement symbols and associated advertisement data at the portable computing device wherein the advertisement symbols and associated advertisement data are transmitted over a network from a content server wherein each of the advertisement symbols is associated with a location within a predetermined area of a location of the portable computing device and wherein the associated advertisement data comprises data displayed on billboard advertisements within a predetermined area of the location of the portable computing device,
display a first user interface at the portable computing device wherein the user interface comprises a display element for each received advertisement symbol wherein the display elements for the received advertisement symbols comprises symbols that are the same symbol as advertisement symbols displayed on billboard advertisements within a predetermined area of the location of the portable computing device and wherein the display elements for the received advertisement symbols and a predetermined number of other display elements are the only display elements on the first user interface that are selectable on the user interface;
when a selectable display element is activated, retrieve at the portable computing device the advertisement data associated with the activated display element, wherein the advertisement data retrieved at the portable computing device for the activated selectable display element comprises a phone number, an address, and additional information, the non-transitory computer readable medium containing further instructions that, when executed by a processor on the portable computing device, cause the portable computing device to:
display a second user interface at the third computing device when the selectable display element of the first user interface is activated, wherein the second user interface consist of a first selection, a second selection, and a third selection, wherein:
when the first selection of the second user interface is activated, the portable computing device calls the phone number associated with the activated display element of the first user interface;
when the second selection of the second user interface is activated, the portable computing device displays the address associated with the activated display element of the first user interface; and
when the third selection of the second user interface is activated, the portable computing device displays the additional information associated with the activated display element of the first user interface.
